(19) United States
(12) Patent Application Publication
(10) Pub. No.: US 2004/0268366 A1
(43) Pub. Date: Dec. 30, 2004

(54) Efficient event delivery

(76) Inventors: Nelson F. Kidd, Tigard, OR (US); Bryan Y. Roe, Camas, WA (US); Ylian Saint-Hilaire, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/603,420

(22) Filed: Jun. 24, 2003

(51) Int. Cl. G06F 9/00

(52) U.S. Cl. 719/318

(57) ABSTRACT

In some embodiments, a state change is received, a flag is set to identify the state change, a moderation period is timed, and an event is sent in response to the flag and in response to the moderation period. Other embodiments are described and claimed.

### TECHNICAL FIELD

The inventions generally relate to efficient handling of events.

### BACKGROUND

Events are delivered in response to a state change of a device by transmitting the event. Events have been handled and delivered in different ways. Many different types of devices need to deliver events corresponding to a variable state change. For example, all UPnP™ devices have to deliver events. However, the delivery of events for some devices is different than others. For example, the delivery of events for some UPnP™ Audio/Video (UPnP™ AV) services is different than events for other UPnP™ services. For more information on UPnP™ see the following web site:

http://upnp.org/.

Specifically, the RenderingControl and AVTransport services of UPnP™ AV report changes in state variables through another XML-formatted state variable (LastChange). In addition to reporting changes of a virtual instance's state variables, the LastChange state variable also needs to employ moderation. That is, each UPnP™ service cannot deliver events more than once every ⅕ th of a second, for example.

One technique of tracking changes in a variable could be to make a copy of each variable after delivery of events corresponding to the variable. Before delivering an event, the current value could be compared to the copied value from the last time the LastChange event was delivered. This is an extremely expensive technique because the amount of memory necessary to track a state of a service is doubled. In the case of string based variables this problem is particularly troublesome because string based variables can sometimes account for 80% of the allocated memory.

Another technique that could be used relates to moderation of the LastChange event. In order to determine when the LastChange event should occur, the progression of time must be tracked (typically using software logic). This requires the software logic to poll the system time until the appropriate amount of time has elapsed. This requires the most recent request to event LastChange to be subject to polling behavior, wasting CPU cycles.

Some techniques rely on inherent delay behavior of a device, hoping that tracking and state changes will take longer than the moderation period. However, this can cause problems, for example, when it is desired the same software for other devices without those inherent delays or where the delays do not actually occur.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 is a block diagram representation of some embodiments of the inventions.

FIG. 2 is a flow diagram of operation of some embodiments of the inventions.

### DETAILED DESCRIPTION

Some embodiments of the inventions relate to efficient handling of events. In some embodiments events corresponding to one or more state changes can be sent in response to a state change flag that identifies a state change and in response to a moderation period.

In some embodiments, a significant improvement may be made in memory usage by using a flag. This can be implemented by setting a bit in a bitstring to identify a variable state change. Instead of keeping an old copy of a variable along with a new copy of the variable for comparison purposes, as little as one bit per state variable may be required. This can allow logic such as software logic to easily track eight state variable changes with one byte (one bit for each variable). In the worst case for a particular variable, overhead for tracking changes only grows by one byte for every eight bits allocated. However, since many variables are string based and most numerical variables are typically two to four bytes a significant improvement is available according to some embodiments. Some embodiments allow overhead to scale with the number of variables rather than the number of allocated bytes for the variables. Lower memory consumption available using some embodiments yields significant cost savings for devices where most of the additional run-time memory needed for the device is for tracking state variables (for example, using UPnP™ AV devices).

In some embodiments, the polling problem can be addressed by employing moderation. Instead of wasting execution cycle time of a software thread checking for the correct time, a timer may be used to wake the executing thread when the correct amount of time has passed. According to some embodiments, the timer relies on the Berkeley Sockets select technique. According to some embodiments, use of a timer allows a software thread to block when it would otherwise be wasting CPU cycles to check the current time. In some embodiments one software thread may be used to deliver events (that is, without requiring a first thread to change the current value and a second thread to compare the current value with a value that was sent previously).

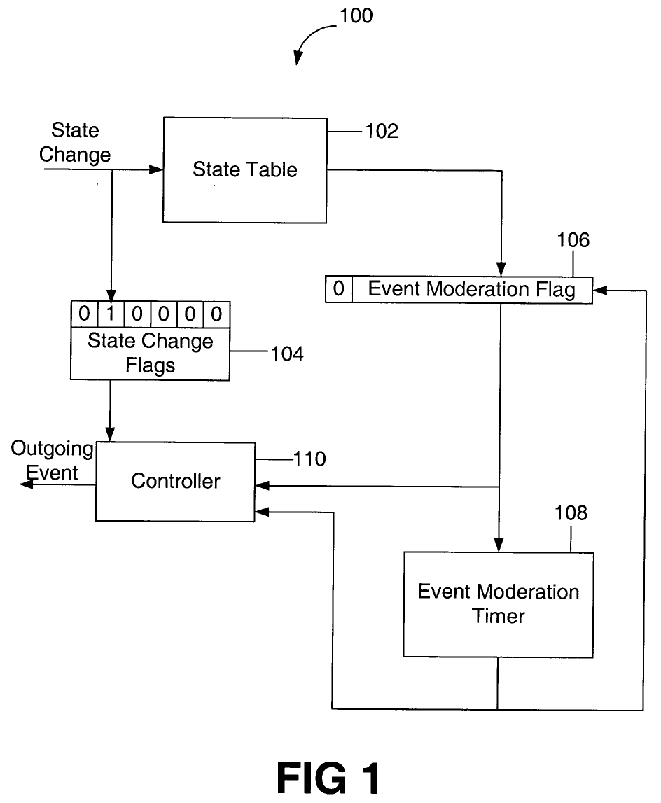

FIG. 1 illustrates an event handling system 100 according to some embodiments. According to some embodiments, system 100 may be implemented in hardware, software, firmware, circuitry, or some combination thereof, but will generally be described herein as being implemented in software. System 100 includes a state table 102, state change flag (or flags) 104, event moderation flag (or flags) 106, event moderation timer 108 and controller 110. State table 102 can be any type of memory that can store information, data, variables, etc. A state change is received at system 100 at the input of state table 102. In some embodiments, the received state change is a UPnP™ state change and/or a UPnP™ AV state change. The state change can be a variable state change arriving from anywhere (for example, from software or from a hardware decoder). State table 102 stores a value corresponding to the state change. This value can be a representation of the changed variable itself or some other representation of the value of the state change. In response to a received state change, a corresponding flag within state change flags 104 is set (for example, to a value of “1” if all state change flags are initially at a value of “0”). The flag within state change flags 104 that is set represents that a state change has been made to a variable corresponding to that flag.

In some embodiments, event moderation flag 106 is initially set to a value of “0”. Upon receipt of a state change event moderation flag 106 is checked. If the value of the event moderation flag 106 is still at “0” then the event moderation flag 106 is set to “1”, the event moderation timer is started and controller 110 sends an event corresponding to the state change for any changed state variables corresponding to particular flags within the state change flags 104 that have been set to “1”. If the value of the event moderation flag 106 is at “1” then no operation is performed. This is because a value of the event moderation flag 106 of “1” represents that an event has recently been sent and the moderation period has not yet finished.

Event moderation timer 108 starts timing a moderation period (in the case of some devices such as UPnP™ and/or UPnP™ AV, this moderation period can be, for example, approximately 1/5 of a second or one second or any other time period). The moderation period can be any amount of time in some embodiments. In some embodiments the moderation period is any time period corresponding to a particular frequency defined by a particular device or type of device having a state change needing event delivery.

Once the moderation period is over, a timer trigger occurs and controller 110 sends an event corresponding to the state change for any changed state variables corresponding to particular flags within the state change flags 104 that have been set to “1”. Then the event moderation flag is reset to “0”. In some embodiments the event moderation flag can be reset to “0” immediately after or substantially at the same time as the sending of the events.

In some embodiments the moderation flag is reset substantially at the same time as the delivery of events. However, flexibility is possible by allowing an implementation to reset the moderation flag before or after event delivery. In some embodiments an implementation that uses multiple threads of execution will reset the moderation flag after event delivery. Controller 110 builds and sends outgoing events for variables based on any state change flags 104 that have been set to a “1” in response to the event moderation flag 106 and the event moderation timer 108. Upon receipt of a state change, if the event moderation flag 106 is “0” (indicating that the event moderation timer 108 is not currently timing a moderation period) then the controller 110 sends outgoing events without waiting for the event moderation timer 108. Upon receipt of a state change, if the event moderation flag 106 is “1” (indicating that the event moderation timer 108 is currently timing a moderation period) then the controller 110 waits until the event moderation timer 108 has finished timing the moderation period and a timer trigger has occurred before sending any outgoing events.

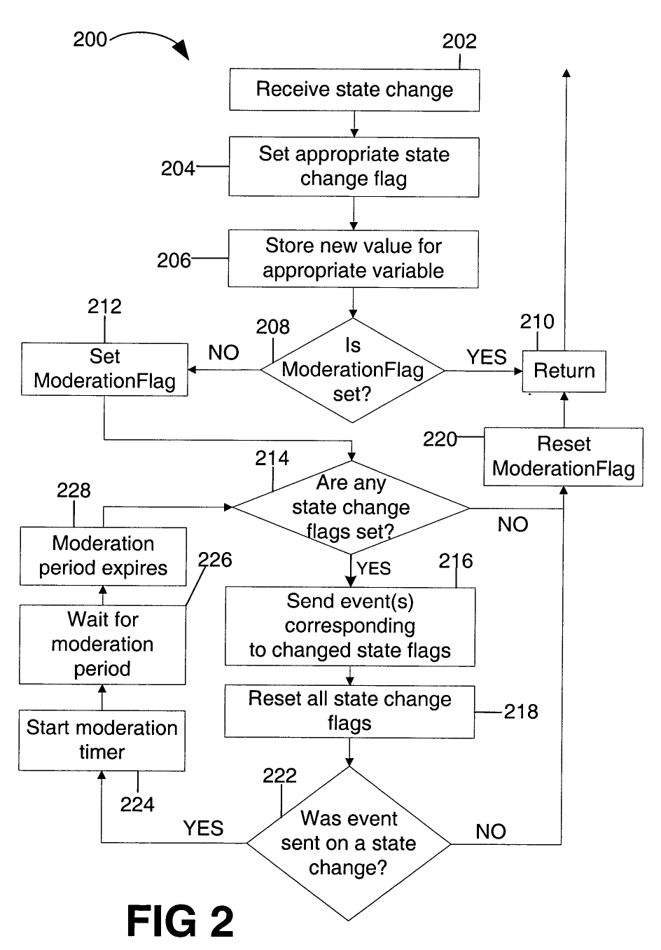

In some embodiments whenever controller 110 delivers an event for the state-change flags that are set (for example, equal to “1”), then immediately after the event delivery (or substantially simultaneously with) those state-change flags are reset (for example, to “0”). State change flags only have the set value (“1”) if the current value of the associated state variable has yet to be reported in an event. Once a state variable's value is reported, the corresponding state change flag is reset (to “0”). FIG. 2 illustrates a flow diagram 200 according to some embodiments. It is noted that other embodiments and modifications to flow diagram 200 may be made, and that flow need not move through each illustrated box or exactly in the same order as illustrated in FIG. 2 and described in reference to FIG. 2.

A state change is received at 202 and an appropriate state change flag is set at 204. The state change flag that is set at 204 may be a flag within state change flags 104 in some embodiments or other flags in some embodiments. Additionally, flags as used herein can include specific flags or any bits, registers, storage locations, memory locations, etc. that store some indicator of a change to one or more state variables, for example. A new value is stored at 206 for the appropriate variable corresponding to the state change received at 202. The new value may be the variable itself stored in a state table such as state table 102 illustrated in FIG. 1 according to some embodiments, or stored in any other place according to some embodiments. A determination is made at 208 as to whether a moderation flag is set. In some embodiments this moderation flag can be a moderation flag such as event moderation flag 106 of FIG. 1. In some embodiments this moderation flag can be any flag. If a moderation flag has been set at 208 flow progresses to return box 210, at which a return is performed. If a moderation flag has not been set at 208 the moderation flag is set at 212.

After the moderation flag has been set at 212 the flow is ready to send an event on a state change via 214, 216 and 218. A determination is made at 214 as to whether any state change flags have been set. In some embodiments these state change flags can be one or more of state change flags 104 as illustrated in FIG. 1. In some embodiments these state change flags can be any flag or flags. If a determination is made at 214 that no state change flags have been set then the moderation flag is reset at 220, and a return is performed at 210.

If a determination is made at 214 that any state change flags have been set then one or more events corresponding to changed state flags are sent at 216. In some embodiments the events are sent at 216 by a controller such as controller 110 of FIG. 1 or some other controller. In some embodiments the events are sent at 216 using any software, hardware, firmware, circuit, or other device or combination thereof. All state change flags are reset at 218 after the events have been sent at 216.

A determination is made at 222 whether or not the event was sent on a state change. The flow to 222 progressing through 202, 204, 206, 208, 212, 214, 216 and 218 indicates an event that was sent on a state change. The flow progressing through 224, 226, 228, 214, 218 and 218 indicates an event that was not sent on a state change. If the event was sent on a state change flow progresses from 222 to 224, at which a moderation timer is started. In some embodiments the moderation timer started at 224 is an event moderation timer such as event moderation timer 108 illustrated in FIG. 1. In some embodiments the moderation timer started at 224 is any timer. In some embodiments the timer started at 224 relies on the Berkeley sockets technique.

After the moderation timer is started at 224 a moderation period is timed at 226. The moderation period expires at 228 and the moderation timer is triggered. After the moderation period expires at 228 the flow is ready to send an event on a time trigger via 214, 216 and 218. Flow progresses from 228 to 214, at which a determination is made as to whether any state change flags are set. If any state change flags are set at 214, any event or events corresponding to changed state flags are sent at 216 and the state change flags are reset at 218. A determination is made at 222 as to whether the event was sent on a state change. Since the event was not sent on a state change and was sent on a time trigger via flow through 224, 226, 228, 214, 216 and 218, flow progresses from 222 to reset the moderation flag at 220 and a return is then performed at 210.

In some embodiments including some embodiments illustrated in FIG. 1 and FIG. 2 the following example illustrates some embodiments. A state change A is received originally while the moderation flag is not set (or at a value “0”). When state change A is received a corresponding state change flag is set. Then the moderation flag is set (for example, to a value “1”), the timer begins timing a moderation period, State change A is sent and the state change flag is reset. If a state change B is received within the moderation period before the timer triggers (for example within ⅕ of a second or one second) after state change A is received then a state change flag corresponding to state change B is set but the event is not sent because the moderation flag is set (e.g., to “1”) and the moderation timer is still timing the moderation period. The same flow occurs if any additional state changes (for example, C, D, E, etc) are received before the moderation period has expired. Once the moderation period expires then the state change B (and C,D,E, etc., if appropriate) are sent. Once state change B (and C,D,E, etc. if appropriate) are sent as events then the moderation flag is reset and flow returns. If any state change F occurs after event B (and C,D,E, etc.) have been sent then flow progresses similarly to when state change A was received and sent as an event.

In some embodiments an event may be delivered using one software thread. In some embodiments a Berkeley Sockets select technique may be used to block the current thread for a specific amount of time. In some embodiments other techniques may be used to block the current thread for a specific amount of time. In some embodiments running standard C programming language a Berkeley Sockets select technique may be used to block the current thread for a specific amount of time. In some embodiments running C sharp programming language other techniques may be used to block the current thread for a specific amount of time.

Some embodiments have been described herein as relating to UPnP™ and/or as relating to UPnP™ AV devices, services, events, etc. While embodiments are particularly useful in a UPnP™ and/or UPnP™ AV environment, those and other embodiments are not limited to UPnP™ or to UPnP™ AV. Some embodiments can be implemented in a UPnP™ implementation, a UPnP™ AV implementation and/or an implementation that is not a UPnP™ implementation.

In some embodiments described herein, the flags such as state change flags and moderation flags have been described as a flag having a set value of “1” and a reset value of “0”. However, the invention is not limited to these types of flags or these types of set and reset values. In some embodiments a set value and a reset value of a flag could be any other value (for example, set could be “0” and reset could be “1”, or set could be “A” and reset could be “B”). In some embodiments any type of binary flag may be used for any or all of the flags described herein. In some embodiments any type of flag may be used for any or all of the flags described herein. In some embodiments any thing that identifies a change in value can be used to implement any or all of the state change flags. In some embodiments anything that identifies a status of a moderation period can be used to implement a moderation flag.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams have been used herein to describe embodiments, the inventions are not limited to those diagrams or to corresponding descriptions herein. For example, flow need not move through each illustrated box or exactly in the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. A method comprising:
receiving a state change;
setting a state change flag;
timing a moderation period;
sending an event in response to the flag and in response to the moderation period; and
resetting the state change flag in response to the sending.

2. The method as claimed in claim 1, further comprising storing a value corresponding to the state change, wherein the sending of the event is further in response to the stored value.

3. The method as claimed in claim 1, further comprising setting a moderation flag approximately corresponding to a beginning of the moderation period and resetting the moderation flag approximately corresponding to an end of the moderation period, wherein the sending of the event is further in response to the moderation flag.

4. The method as claimed in claim 3, further comprising storing a value corresponding to the state change, wherein the sending of the event is further in response to the stored value.

5. The method as claimed in claim 1, wherein the resetting occurs substantially simultaneously with the sending.

6. The method as claimed in claim 1, wherein the resetting occurs after the sending.

7. The method as claimed in claim 1, wherein the state change is a UPnP™ state change and the event is a UPnP™ event.

8. The method as claimed in claim 1, wherein the moderation period is approximately 1/5 of a second.

9. The method as claimed in claim 1, wherein the moderation period is approximately one second.

10. The method as claimed in claim 3, wherein the sending sends the event if the flag is set and if the moderation flag is not set.

11. The method as claimed in claim 1, wherein the sending sends the event if the flag is set and the moderation period has expired.

12. The method as claimed in claim 1, wherein the sending sends the event if the flag is set and the moderation period has not begun.

13. An article comprising:
a computer readable medium having instructions thereon which when executed cause a computer to:
receive a state change;
set a state change flag;
time a moderation period;
send an event in response to the flag and in response to the moderation period; and
reset the state change flag in response to the sending.

14. The article as claimed in claim 13, wherein the instructions when executed further cause a computer to store a value corresponding to the state change, wherein the event is sent further in response to the stored value.

15. The article as claimed in claim 13, wherein the instructions when executed further cause a computer to set a moderation flag approximately corresponding to a beginning of the moderation period and reset the moderation flag approximately corresponding to an end of the moderation period, wherein the event is sent further in response to the moderation flag.

16. The article as claimed in claim 13, wherein the reset occurs after the event is sent.

17. The article as claimed in claim 15, wherein the instructions when executed further cause a computer to send the event if the flag is set and if the moderation flag is not set.

18. The article as claimed in claim 13, wherein the instructions when executed further cause a computer to send the event if the flag is set and the moderation period has expired.

19. The article as claimed in claim 13, wherein the instructions when executed further cause a computer to send the event if the flag is set and the moderation period has not begun.

20. A system comprising:
a state change flag responsive to a state change;
a moderation timer; and
a controller to send an event in response to the state change flag and in response to the moderation timer.

21. The system as claimed in claim 20, further comprising a state table to store a value corresponding to the state change, wherein the controller is to send the event in response to the value, the state change flag and the moderation timer.

22. The system as claimed in claim 20, further comprising an event moderation flag, wherein the controller is to send the event in response to the moderation flag, the state change flag and the moderation timer.

23. The system as claimed in claim 22, further comprising a state table to store a value corresponding to the state change, wherein the controller is to send the event in response to the value, the moderation flag, the state change flag and the moderation timer.

24. The system as claimed in claim 20, wherein the system is a UPnP™ system and the controller is to send UPnP™ events.

25. The system as claimed in claim 20, wherein the moderation timer has a moderation period of approximately 1/5 of a second.

26. A system as claimed in claim 20, wherein the moderation timer has a moderation period of approximately one second.
